(19) United States
(12) Patent Application Publication
(10) Pub. No.: US 2019/0097801 A1
(43) Pub. Date: Mar. 28, 2019

(54) Apparatus for Protection of Electronic Circuitry and Associated Methods

(71) Applicant: Silicon Laboratories Inc., Austin, TX (US)

(72) Inventor: Javier Elenes, Austin, TX (US)

(21) Appl. No.: 15/717,928

(22) Filed: Sep. 27, 2017

(51) Int. Cl. H04L 9/32; G06F 21/57

(52) U.S. Cl. CPC H04L 9/32; G06F 2221/034; G06F 21/57

(57) ABSTRACT

A method of providing access to a resource in an integrated circuit (IC) includes determining whether an attempt is made to access the resource. The method also includes determining whether a count of attempts to access the resource equals a maximum count. The method further includes authenticating cryptographically a command for accessing the resource if the count of attempts to access the resource is less than the maximum count.

### CROSS-REFERENCE TO RELATED APPLICATIONS

This application is related to U.S. patent application Ser. No. ______, titled “Apparatus for Clock-Frequency Variation in Electronic Circuitry and Associated Methods,” attorney docket number SILA396.

### TECHNICAL FIELD

The disclosure relates generally to security and protection of electronic circuitry and, more particularly, to apparatus for securing or protecting electronic circuitry against attacks, and associated methods.

### BACKGROUND

With advances in technology, an increasing number of circuit elements have been integrated into devices, such as integrated circuits (ICs). Furthermore, a growing number of devices, such as ICs, or subsystems, have been integrated into products. With developments such as the Internet of Things (IoT), this trend is expected to continue.

With the increasing complexity of electronic devices, such as ICs, attention has also turned to securing such devices. The growing number of circuit elements, devices, subsystems, etc., has also resulted in a corresponding increase in the number of attack vectors that may be used to compromise the security of such devices

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, method of providing access to a resource in an IC includes determining whether an attempt is made to access the resource. The method also includes determining whether a count of attempts to access the resource equals a maximum count. The method further includes authenticating cryptographically a command for accessing the resource if the count of attempts to access the resource is less than the maximum count.

According to one exemplary embodiment, method of providing access to a resource in an IC includes determining whether an attempt is made to access the resource. The method also includes waiting for a duration of time, wherein the duration of time is zero for a first attempt to access the resource. The method further includes authenticating cryptographically a command for accessing the resource, and selectively allowing access to the resource if authenticating cryptographically the command indicates that the command is valid.

According to another exemplary embodiment, an IC includes a protection circuit to provide countermeasures against an attempt to access a resource in the IC. The protection circuit comprising a controller to selectively provide access to the resource in the IC by authenticating a command by (a) determining whether a count of attempts exceeds a maximum count; or (b) inserting a wait state before authenticating the command.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 shows a conventional technique for attacking an electronic device.

FIG. 2 shows another conventional technique for attacking an electronic device

FIG. 3 shows a flow diagram for a process of authenticating access to a resource in an electronic device according to an exemplary embodiment.

FIG. 4 shows a circuit arrangement for authenticating access to a resource in an electronic device according to an exemplary embodiment.

FIG. 5 shows a flow diagram for a process of authenticating access to a resource in an electronic device according to an exemplary embodiment.

FIG. 6 shows a circuit arrangement for authenticating access to a resource in an electronic device according to an exemplary embodiment.

FIG. 7 shows a block diagram of an IC that includes protection circuitry according to an exemplary embodiment.

FIG. 8 shows a block diagram of a system for information processing according to an exemplary embodiment.

### DETAILED DESCRIPTION

The disclosed concepts relate generally to security and protection of electronic circuitry or devices, such as ICs (generally electronic circuitry). More specifically, the disclosed concepts provide apparatus and methods for securing or protecting electronic circuitry against attacks. In various embodiments, the protection takes the form of countermeasures against attacks, and may be applied to various resources or tokens associated with or included in the electronic circuitry.

As described below, apparatus and associated methods according to various embodiments provide countermeasures to attacks (e.g., hostile attempts to access resources or tokens) against electronic circuitry. The countermeasures provide a mechanism for thwarting attacks against resources or tokens in the electronic circuitry.

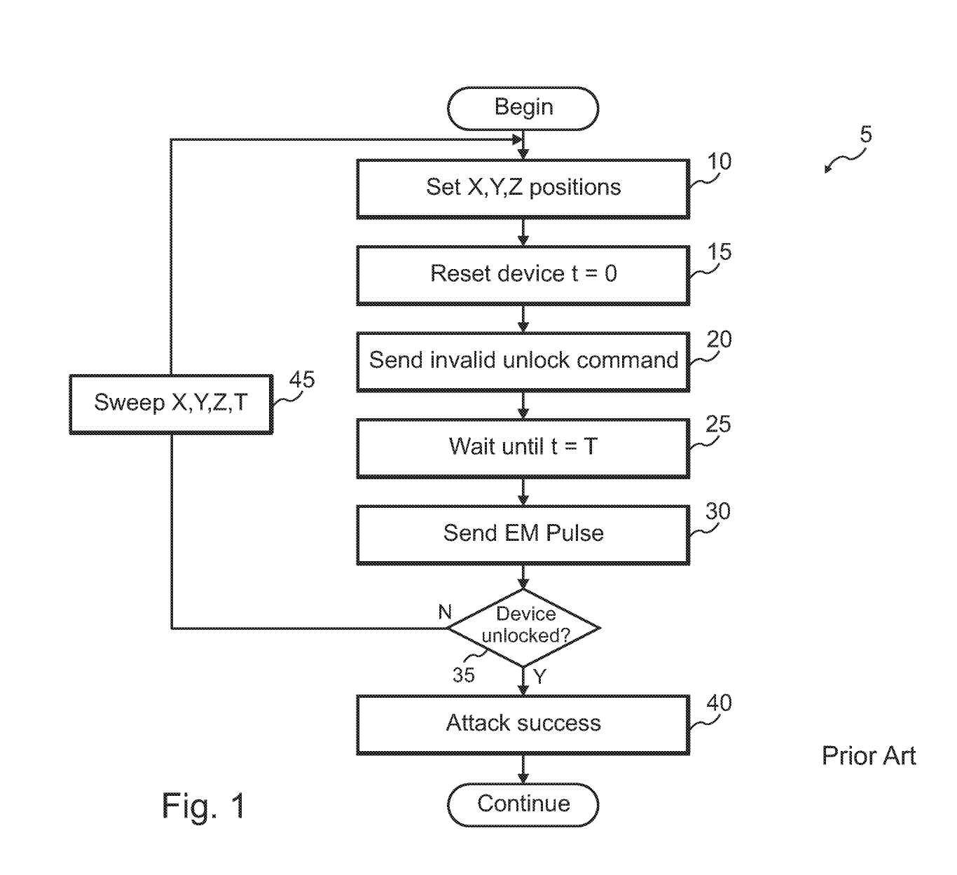

FIG. 1 shows a flow diagram 5 for a conventional process for attacking an electronic device. The purpose of the attack is to access certain features or circuitry of the IC.

The process involves the application of an electromagnetic (EM) pulse to attack the electronic device, such as an IC. In the process shown, the EM pulse is used to unlock the IC and, thus, gain access to it.

At 10, x, y, and z positions or coordinates are set for the apparatus that applies the EM pulse with respect to the IC. The x, y, and z coordinates pertain to the positioning of the EM pulse apparatus relative to the IC to be subjected to the EM pulse.

At 15, the IC is reset, e.g., by applying an appropriate voltage or signal to a reset pin of the IC. The device reset occurs at an initial time, i.e., time t=0.

In response to the reset signal or voltage the IC is reset, and is therefore in a generally known configuration. At 20, an invalid unlock command is sent to the IC.

At 25, a wait period is exercised. In this particular case, the process waits until a period T has passed. In other words, the process waits until t=T. The parameter T denotes a wait period, the value of which depends on various factors, such as the characteristics of the apparatus that applies the EM pulse, the attributes of the EM pulse (e.g., how rapidly it affects the electronic device), the characteristics of the IC, etc.

At 30, the EM pulse is sent or applied to the IC. As persons of ordinary skill in the art know, a variety of apparatus and techniques may be used to apply the EM pulse to the IC. For example, a probe may apply a high voltage or electromagnetic field to the packaging of the IC. The application of the EM pulse is meant to unlock the IC, for example, by bypassing its security features. As persons of ordinary skill in the art understand, however, other techniques for injecting faults exist, and may be applied, as desired. Examples include shining a laser on a specific part of the circuit, or applying a voltage pulse directly into the IC die with a tungsten probe. These methods entail de-capsulating the device to gain physical access to the die.

At 35 a check is made whether the IC is unlocked as a result of the application of the EM pulse. The check may be made, for example, by determining whether some circuitry in the IC may be accessed.

If so, at 40 the attack is deemed successful. The attacker may subsequently use the various features or circuitry in the IC for general or specific purposes.

If not, at 45 the x, y, and z coordinates and the time period T are swept. More specifically, new or updated values for x, y, and z coordinates and the time period T are selected in preparation for another attack on the IC. The new or updated values are selected using a variety of techniques, as persons of ordinary skill in the art understand.

Control is subsequently returned to 10. The new or updated x, y, and z coordinates and the time period T are set. Thereafter another attack is performed, as described above.

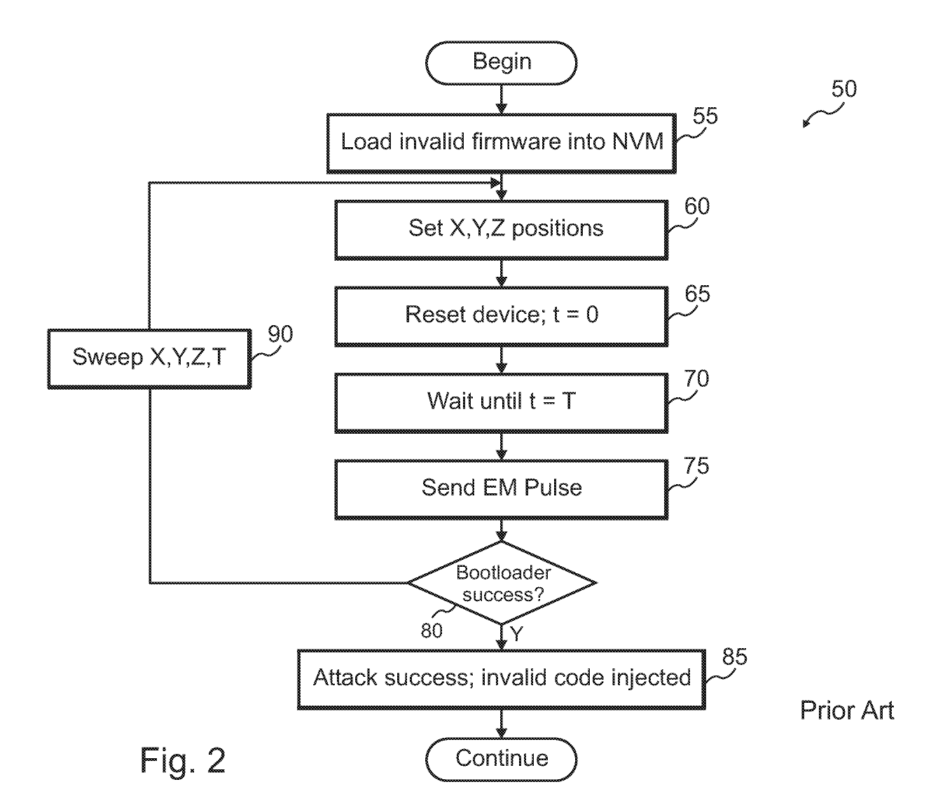

FIG. 2 shows another flow diagram 50 for a conventional process for attacking an electronic device. In this case, attempt(s) are made to unlock an IC in order to load invalid (or malicious) firmware into it. Similar to the process described in connection with FIG. 1, the process shown in FIG. 2 involves the application of an EM pulse to attack the electronic device, such as an IC. In the process shown, the EM pulse is used to unlock the IC in order to update its firmware. As noted above, however, techniques other than applying EM pulses may be used to attack the IC or inject fault.

At 55, the invalid firmware is loaded into the non-volatile memory (NVM) of the IC. The NVM holds firmware that is typically used to boot or start the IC, such as a microcontroller unit (MCU).

At 60, x, y, and z positions or coordinates are set for the apparatus that applies the EM pulse with respect to the IC. The x, y, and z coordinates pertain to the positioning of the EM pulse apparatus relative to the IC to be subjected to the EM pulse.

At 65, the IC is reset, e.g., by applying an appropriate voltage or signal to a reset pin of the IC. The device reset occurs at an initial time, i.e., time t=0. In response to the reset signal or voltage the IC is reset, and is therefore in a generally known configuration.

At 70, a wait period is exercised. In this particular case, the process waits until a period T has passed. In other words, the process waits until t=T. The parameter T denotes a wait period, the value of which depends on various factors, such as the characteristics of the apparatus that applies the EM pulse, the attributes of the EM pulse (e.g., how rapidly it affects the electronic device), the characteristics of the IC, etc.

At 75, the EM pulse is sent or applied to the IC. As persons of ordinary skill in the art know, a variety of apparatus and techniques may be used to apply the EM pulse to the IC. For example, a probe may apply a high voltage or electromagnetic field to the packaging of the IC. The application of the EM pulse is meant to unlock the IC, for example, by bypassing its security features.

At 80 a check is made whether, as a result of the application of the EM pulse, the IC bootloader succeeds with the invalid firmware loaded. If so, at 85 the attack is deemed successful, as invalid code is injected into the IC. The attacker may subsequently use the various features or circuitry in the IC for general or specific purposes.

If not, at 90 the x, y, and z coordinates and the time period T are swept. More specifically, new or updated values for x, y, and z coordinates and the time period T are selected in preparation for another attack on the IC. The new or updated values are selected using a variety of techniques, as persons of ordinary skill in the art understand.

Control is subsequently returned to 55. The new or updated x, y, and z coordinates and the time period T are set. Thereafter another attack is performed, as described above.

One aspect of the disclosure relates to defending or protecting against an attack by authenticating commands as part of the attack. The commands may generally seek to access, use, program, or otherwise manipulate one or more resources in an electronic device, such as an IC.

Without limitation, the resource may be a token, an interface, a circuit, a block, hardware, firmware, software, or other resource in an electronic device, such as IC, as persons of ordinary skill in the art will understand.

In cases where the resource is an interface, the interface may constitute a variety of devices, circuits, or blocks, as persons of ordinary skill in the art will understand. Without limitation, the interface may constitute a debug interface. Examples of debug interfaces include serial interfaces, Joint Test Action Group (JTAG) interfaces, parallel interfaces, interfaces to access memory or other resource in an IC, etc.

In the case of a debug interface, the interface is typically open during development, production, and test of the IC, such as an MCU. Access to the debug interface typically grants full access to the various resources of the IC, and full control of it.

As such, access to the debug interface may provide access to other secret or valuable information. Examples include secret keys or tokens, data, and the like. Examples of secret keys or tokens include private keys (e.g., as used in a public-private key infrastructure or setup), passwords, passphrases, secret words or phrases, hashes of passwords, encryption keys (e.g., Advanced Encryption Standard (AES) keys), cipher keys, and the like, as persons of ordinary skill in the art will understand.

Because of the sensitive information that may be accessed via the debug interface, the debug interface is typically locked down before the IC is shipped for general or field use. Access to the debug interface may be desired later, for example, to determine faults or defects in the IC, such as might develop during field use.

To regain access to the IC, typically cryptographic authentication (for example, using one of the techniques described above) is used. A number of attacks, such as those described above, may be used by an attacker to bypass or circumvent the authentication in order to gain access to the resources, such as cryptographic resources. Exemplary embodiments provide protection or countermeasures against such attacks.

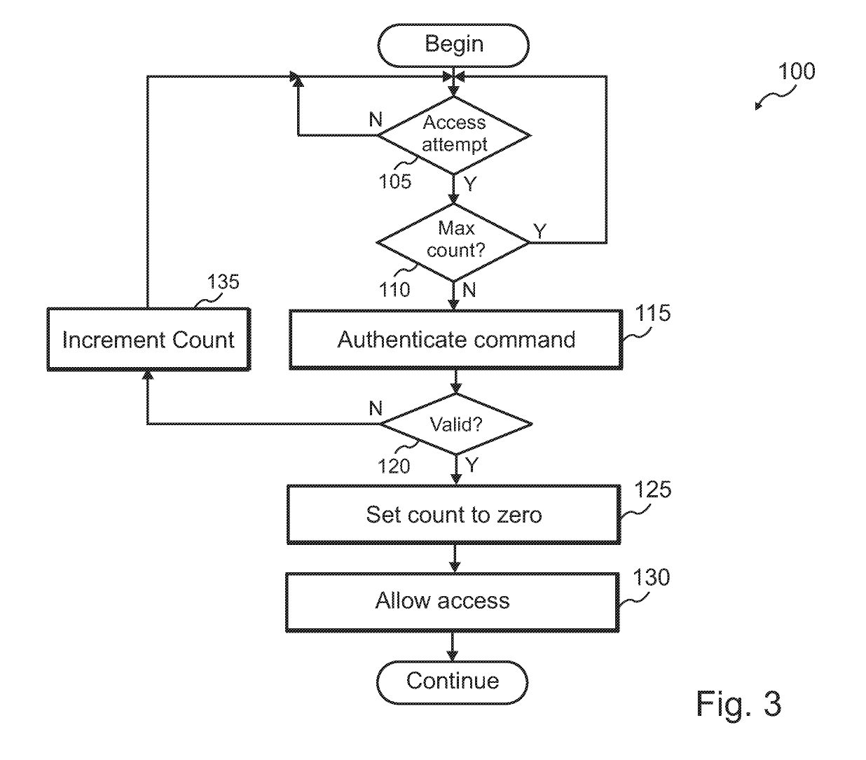

FIG. 3 shows a flow diagram 100 for a process of authenticating access to a resource in an electronic device according to an exemplary embodiment. At 105 a check is made for an attempt to access the resource in the IC, such as the resources mentioned above. Attempting access to the resource may entail using an authentication token, such as certificate, secret key, etc., as persons of ordinary skill in the art will understand.

If no attempt is made for access, control returns to 105. Otherwise, if an access attempt is made or detected, control is passed to 110.

At 110, a check is made whether a maximum count (e.g., a threshold or maximum value of attempts) has been reached, as the countermeasure against the attack uses a count of the access attempts to compare against the maximum count. If so, control returns to 105, and the process waits for another access attempt.

If not, at 115 the command used to attempt access is authenticated. The authentication may be made using a variety of techniques, such as the techniques described above (decryption, cryptography, etc.).

At 120 a check is made whether the command was successfully authenticated and, thus, is a valid command for gaining access to the resource. If not, at 135 the count of the number of access attempts is incremented, and control returns to 105.

If valid, however, at 125 the count of access attempts is set to zero. At 130, access to the resource is allowed.

In some embodiments, in addition to incrementing the count at 135, a delay (e.g., as measured or implemented with a timer) may be used before control returns to 105. Using the delay allows limiting the rate at which an attacker may attempt accessing the resource.

Note that a variety of ways to increment the count at 135 may be used, as desired. In some embodiments, the count may be incremented linearly (e.g., using an arithmetic series or sequentially). In some embodiments, the count may be incremented geometrically (e.g., using a geometric series). In some embodiments, the count may be incremented exponentially. In some embodiments, the count may initially be incremented linearly, and on subsequent access attempts may be incremented by larger increments, e.g., geometrically or exponentially. Other ways of incrementing the count are possible and are contemplated, as persons of ordinary skill in the art will understand.

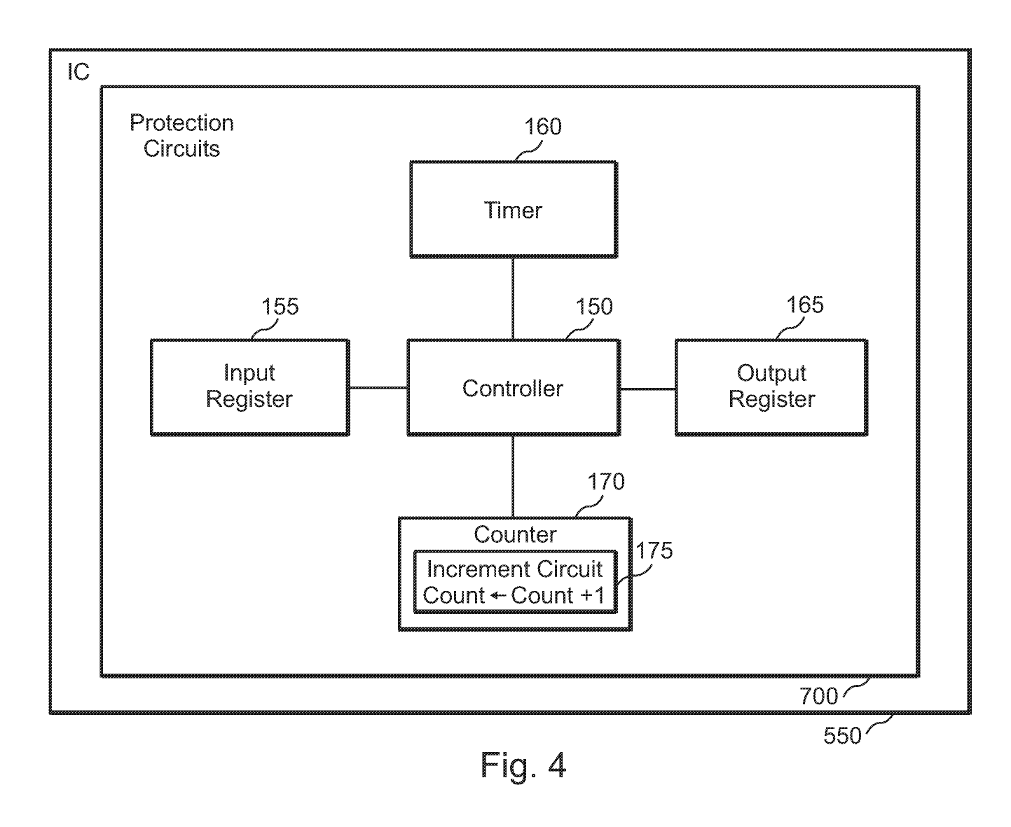

FIG. 4 shows a circuit arrangement for authenticating access to a resource in an electronic device, such as IC 550, according to an exemplary embodiment. More specifically, the circuit arrangement may be used to implement or realize the countermeasure process shown in FIG. 3, and thus constitutes an IC protection circuit.

Referring again to FIG. 4, IC 550 includes a controller 150, which controls the process of authenticating commands and allowing (or disallowing) access to the resource. Controller 150 is coupled to timer 160. Timer 160 may optionally be used to provide timing for various operations of controller 150 and/or other components, for example, for cryptographic operations, and the like. In some embodiments, timer 160 may be used to implement or generate a delay (e.g., to limit the rate at which access attempts may be made, as described above).

Controller 150 is also coupled to counter 170. Counter 170 may be used to count up or down, etc., in order to facilitate the operation of controller 150 and, generally, protection circuitry used to provide attack countermeasures.

Counter 170 includes increment circuit 175. Increment circuit 175 may be used to increment a value or number, such as the count of the number of access attempts, as described above.

Controller 150 is further coupled to an input register 155. Via input register 155, controller 150 receives information related to accessing resources in the IC, for example, commands for access, authentication tokens, etc.

Controller 150 is also coupled to an output register 165. Via output register 165, controller 150 provides information related to accessing resources in the IC, for example, information or commands that cause the grant of access to resources in the IC.

In some embodiments, output register 165 may provide information (e.g., bit patterns) that act as configuration information for the resource access to which is sought. In some embodiments, output register 165 may provide information (e.g., flags) that may be used by one or more other circuits in the IC, such as cryptographic circuitry, processor(s), etc., in order to authenticate tokens, cause the grant of access to the resource sought, etc.

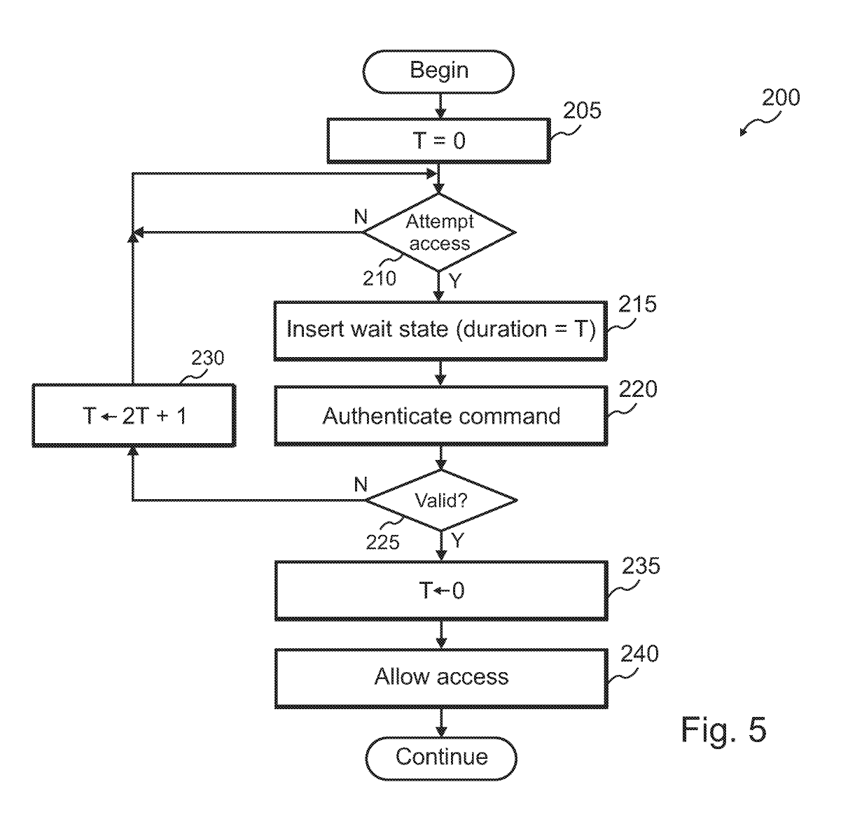

FIG. 5 shows a flow diagram 200 for another process of authenticating access to a resource in an electronic device according to an exemplary embodiment. The process authenticates access to resource(s) in an IC, as described above in connection with FIG. 3.

Referring again to FIG. 5, the process shown in this embodiment uses a delay (or wait) time or period as a countermeasure against attacks. At 205, the value of a delay period is initialized to 0, i.e., T=0.

At 210 a check is made for an attempt to access the resource in the IC, such as the resources mentioned above. Attempting access to the resource may entail using an authentication token, such as certificate, secret key, etc., as persons of ordinary skill in the art will understand.

If no attempt is made for access, control returns to 210. Otherwise, if an access attempt is made or detected, control is passed to 215. At 215, a wait state is inserted into the process. The duration of the wait state is specified by T. In other words, T denotes a wait or delay period. Note that the first time control is passed to 215, T has been initialized to zero, which means no additional delay is inserted into the process.

At 220 the command used to attempt access is authenticated. The authentication may be made using a variety of techniques, such as the techniques described above (decryption, cryptography, etc.).

At 225 a check is made whether the command was successfully authenticated and, thus, is a valid command for gaining access to the resource. If not, at 230 the value of T is increased, and control returns to 210. In the embodiment shown, the value of T is changed to the quantity (2T+1). Thus, if control subsequently returns to 215, the period of the wait state is (2T+1), rather than T. In other words, the amount of wait time or delay between successive attempts to access the resource is increased, which acts as a countermeasure against attacks.

Note that a variety of ways to change the value of T may be used, as desired. In some embodiments, the value of T might change linearly (e.g., using an arithmetic series). In some embodiments, the value of T might increase geometrically (e.g., using a geometric series). In some embodiments, the value of T might increase exponentially. In some embodiments, the value of T might initially increase linearly, and on subsequent access attempts may increase more rapidly, e.g., geometrically or exponentially. Other ways of changing the value of T are possible and are contemplated, as persons of ordinary skill in the art will understand.

Referring again to 225, if the command was successfully authenticated and, thus, is a valid command for gaining access to the resource, control passes 235. At 235, the value of T is reset to zero. At 240, access to the resource is allowed.

In some embodiments, in addition to incrementing the count at 135, a delay (e.g., as measured or implemented with a timer) may be used before control returns to 105. Using the delay allows limiting the rate at which an attacker may attempt accessing the resource.

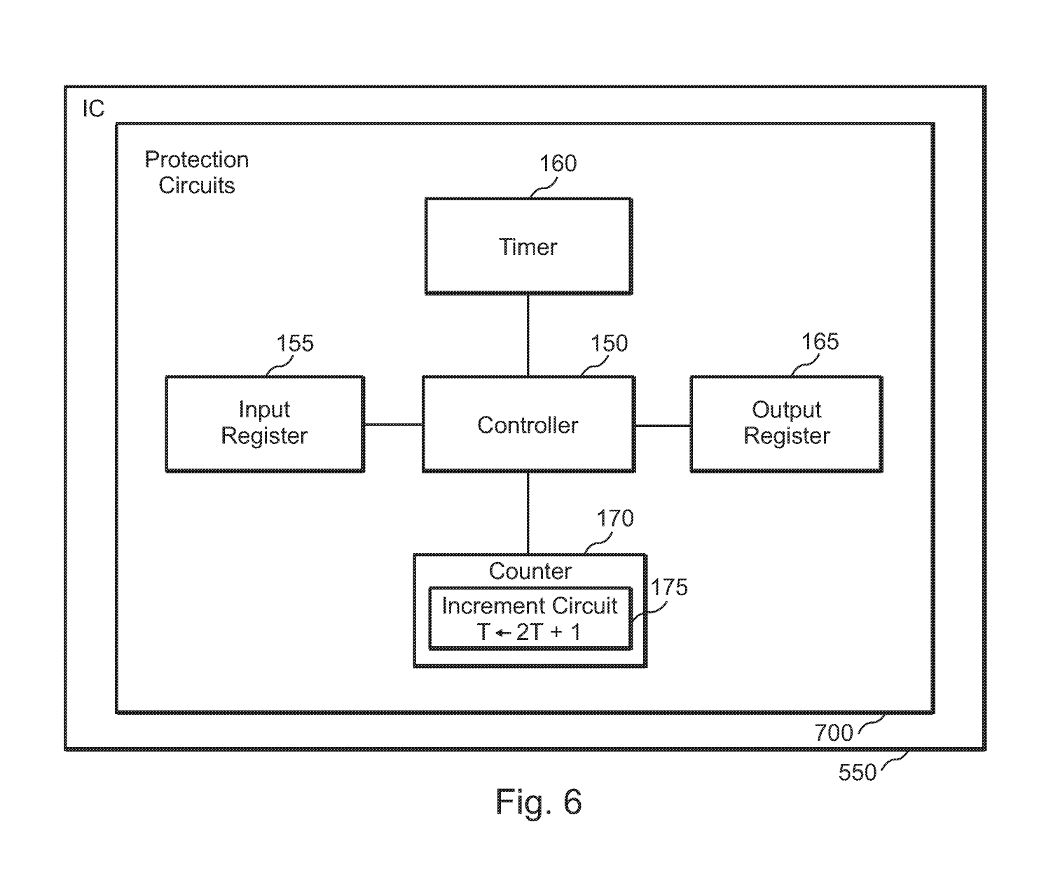

FIG. 6 shows a circuit arrangement for authenticating access to a resource in an electronic device, such as IC 550, according to an exemplary embodiment. More specifically, the circuit arrangement may be used to implement or realize the countermeasure process shown in FIG. 5, and thus constitutes an IC protection circuit.

Referring again to FIG. 6, IC 550 includes a controller 150, which controls the process of authenticating commands and allowing (or disallowing) access to the resource. Controller 150 is coupled to timer 160. Timer 160 is used to provide timing for various operations of controller 150 and/or other components, for example, for cryptographic operations, and the like. Referring to the embodiment in FIG. 5, timer 160 may be used to implement or generate a delay or wait time, such as T, described above.

Referring again to FIG. 6, controller 150 is also coupled to counter 170. Counter 170 may be used to count up or down, etc., in order to facilitate the operation of controller 150 and, generally, protection circuitry used to provide attack countermeasures.

Counter 170 includes increment circuit 175. Increment circuit 175 may be used to increment a value or number, such as the count of the number of access attempts, as described above. In exemplary embodiments, the increment operation may occur sequentially (increase by 1), linearly (e.g., 2T+1, as described above), geometrically, exponentially, or a combination of any of the foregoing schemes, as desired.

Controller 150 is further coupled to an input register 155. Via input register 155, controller 150 receives information related to accessing resources in the IC, for example, commands for access, authentication tokens, etc.

Controller 150 is also coupled to an output register 165. Via output register 165, controller 150 provides information related to accessing resources in the IC, for example, information or commands that cause the grant of access to resources in the IC.

In some embodiments, output register 165 may provide information (e.g., bit patterns) that act as configuration information for the resource access to which is sought. In some embodiments, output register 165 may provide information (e.g., flags) that may be used by one or more other circuits in the IC, such as cryptographic circuitry, processor(s), etc., in order to authenticate tokens, cause the grant of access to the resource sought, etc.

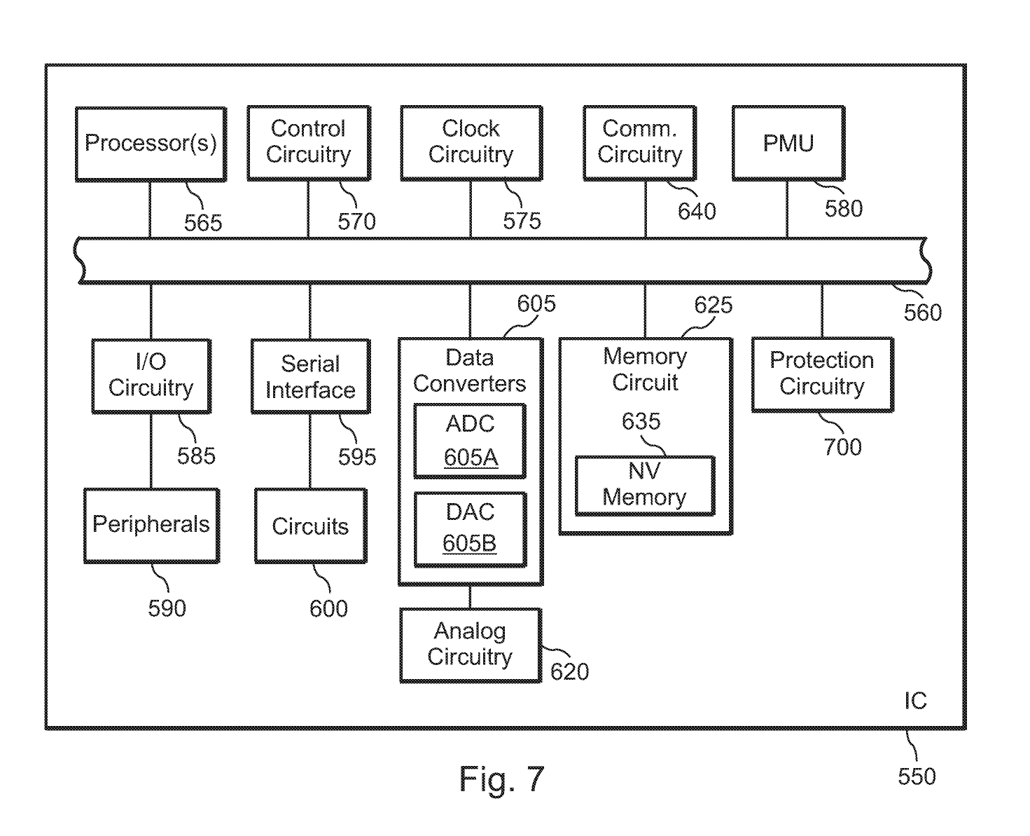

According to one aspect of the disclosure, apparatus and associated methods for protecting electronic circuitry and devices against attacks may be used with or included in a variety of circuits, blocks, subsystems, and/or systems. For example, in some embodiments, protection circuitry, such as circuitry described above to authenticate access to various resources or tokens, may be integrated in an IC, such as an MCU. FIG. 7 shows a circuit arrangement for such an exemplary embodiment.

The circuit arrangement includes an IC 550, which constitutes or includes an MCU. IC 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductor elements (e.g., traces, devices, etc.) for communicating information, such as data, commands, status information, and the like.

IC 550 may include link 560 coupled to one or more processors 565, clock circuitry 575, and power management circuitry or power management unit (PMU) 580. In some embodiments, processor(s) 565 may include circuitry or blocks for providing information processing (or data processing or computing) functions, such as central-processing units (CPUs), arithmetic-logic units (ALUs), and the like. In some embodiments, in addition, or as an alternative, processor(s) 565 may include one or more DSPs. The DSPs may provide a variety of signal processing functions, such as arithmetic functions, filtering, delay blocks, and the like, as desired.

In some embodiments, processor(s) 565 may be used in conjunction with protection circuitry 700. For example, if processor(s) 565 includes circuitry or other resources for authenticating commands or requests, such circuitry or resources may be used with protection circuitry 700, or may replace part of protection circuitry 700, as desired. Protection circuitry 700 generally provides countermeasures against attacks, as described in further detail below.

Clock circuitry 575 may generate one or more clock signals that facilitate or control the timing of operations of one or more blocks in IC 550. Clock circuitry 575 may also control the timing of operations that use link 560, as desired. In some embodiments, clock circuitry 575 may provide one or more clock signals via link 560 to other blocks in IC 550, such as protection circuitry 700.

In some embodiments, PMU 580 may reduce an apparatus's (e.g., IC 550) clock speed, turn off the clock, reduce power, turn off power, disable (or power down or place in a lower power consumption or sleep or inactive or idle state), enable (or power up or place in a higher power consumption or normal or active state) or any combination of the foregoing with respect to part of a circuit or all components of a circuit, such as one or more blocks in IC 550. Further, PMU 580 may turn on a clock, increase a clock rate, turn on power, increase power, or any combination of the foregoing in response to a transition from an inactive state to an active state (including, without limitation, when processor(s) 565 make a transition from a low-power or idle or sleep state to a normal operating state).

Link 560 may couple to one or more circuits 600 through serial interface 595. Through serial interface 595, one or more circuits or blocks coupled to link 560 may communicate with circuits 600. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with one or more blocks coupled to link 560, e.g., processor(s) 365, memory circuit 625, etc.

In exemplary embodiments, peripherals 590 may include a variety of circuitry, blocks, and the like. Examples include I/O devices (keypads, keyboards, speakers, display devices, storage devices, timers, sensors, etc.). Note that in some embodiments, some peripherals 590 may be external to IC 550. Examples include keypads, speakers, and the like.

In some embodiments, with respect to some peripherals, I/O circuitry 585 may be bypassed. In such embodiments, some peripherals 590 may couple to and communicate with link 560 without using I/O circuitry 585. In some embodiments, such peripherals may be external to IC 550, as described above.

Link 560 may couple to analog circuitry 620 via data converter(s) 605. Data converter(s) 605 may include one or more ADCs 605A and/or one or more DACs 605B.

ADC(s) 605A receive analog signal(s) from analog circuitry 620, and convert the analog signal(s) to a digital format, which they communicate to one or more blocks coupled to link 560. Conversely, DAC(s) 605B receive digital signal(s) from one or more blocks coupled to link 560, and convert the digital signal(s) to analog format, which they communicate to analog circuitry 620.

Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to IC 550 to form more complex systems, sub-systems, control blocks or systems, feedback systems, and information processing blocks, as desired.

Control circuitry 570 couples to link 560. Thus, control circuitry 570 may communicate with and/or control the operation of various blocks coupled to link 560 by providing control information or signals. In some embodiments, control circuitry 570 also receives status information or signals from various blocks coupled to link 560. In addition, in some embodiments, control circuitry 570 facilitates (or controls or supervises) communication or cooperation between various blocks coupled to link 560. In some embodiments, control circuitry 570 may operate in conjunction with controller 150 (see FIGS. 4 and 6). In some embodiments, some or all of the circuitry in control circuitry 570 may replace some or all of the circuitry in controller 150, as desired.

In some embodiments, control circuitry 570 may initiate or respond to a reset operation or signal. The reset operation may cause a reset of one or more blocks coupled to link 560, of IC 550, etc., as person of ordinary skill in the art will understand. For example, control circuitry 570 may cause PMU 580, and circuitry such as protection circuitry 700, to reset to an initial or known state.

In exemplary embodiments, control circuitry 570 may include a variety of types and blocks of circuitry. In some embodiments, control circuitry 570 may include logic circuitry, finite-state machines (FSMs), or other circuitry to perform operations such as the operations described above.

Communication circuitry 640 couples to link 560 and also to circuitry or blocks (not shown) external to IC 550. Through communication circuitry 640, various blocks coupled to link 560 (or IC 550, generally) can communicate with the external circuitry or blocks (not shown) via one or more communication protocols. Examples of communications include USB, Ethernet, and the like. In exemplary embodiments, other communication protocols may be used, depending on factors such as design or performance specifications for a given application, as person of ordinary skill in the art will understand.

As noted, memory circuit 625 couples to link 560. Consequently, memory circuit 625 may communicate with one or more blocks coupled to link 560, such as processor(s) 365, control circuitry 570, I/O circuitry 585, etc.

Memory circuit 625 provides storage for various information or data in IC 550, such as operands, flags, data, instructions, and the like, as persons of ordinary skill in the art will understand. Memory circuit 625 may support various protocols, such as double data rate (DDR), DDR2, DDR3, DDR4, and the like, as desired.

In some embodiments, memory read and/or write operations by memory circuit 625 involve the use of one or more blocks in IC 550, such as processor(s) 565. A direct memory access (DMA) arrangement (not shown) allows increased performance of memory operations in some situations. More specifically, DMA (not shown) provides a mechanism for performing memory read and write operations directly between the source or destination of the data and memory circuit 625, rather than through blocks such as processor(s) 565.

Memory circuit 625 may include a variety of memory circuits or blocks. In the embodiment shown, memory circuit 625 includes non-volatile (NV) memory 635. In addition, or instead, memory circuit 625 may include volatile memory (not shown), such as random access memory (RAM). NV memory 635 may be used for storing information related to performance, control, or configuration of one or more blocks in IC 550. For example, NV memory 635 may store configuration information related to protection circuitry 700.

In exemplary embodiments, protection circuitry 700 includes some or all of the circuitry used to authenticate access to one or more tokens or resources in IC 550. For example, in some embodiments, protection circuitry 700 may include the circuitry shown in FIG. 4. As another example, in some embodiments, protection circuitry 700 may include the circuitry shown in FIG. 6. As another example, in some embodiments, protection circuitry 700 may include the circuitry shown in both FIG. 4 and in FIG. 6.

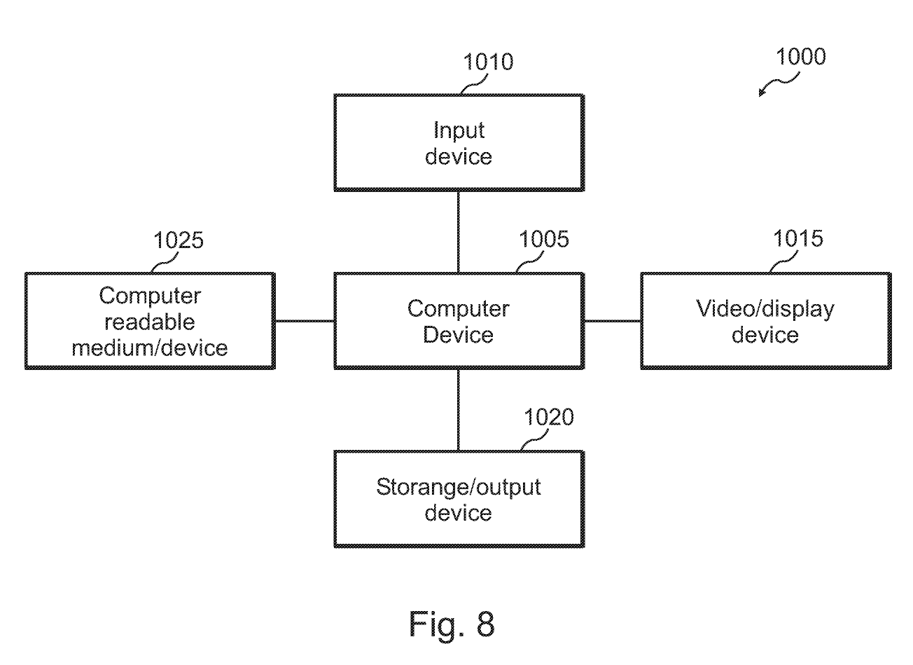

According to one aspect of the disclosure, one may perform, run, or execute the disclosed algorithms, processes, methods, or software on computer systems, devices, processors, controllers, etc. FIG. 8 shows a block diagram of an exemplary system 1000 for processing information that may be used in exemplary embodiments. For example, in some embodiments, system 1000 may be used to realize or implement one or more processes for providing countermeasures against attacks, such as the processes shown in FIG. 3 and/or FIG. 5. Without limitation, system 1000 may be used in exemplary embodiments for authenticating access to resources in an electronic device, such as an IC, according to various embodiments, such as those described above.

System 1000 includes a computer device 1005, an input device 1010, a video/display device 1015, and a storage/output device 1020, although one may include more than one of each of those devices, as desired. Computer device 1005 couples to input device 1010, video/display device 1015, and storage/output device 1020. System 1000 may include more than one computer device 1005, for example, a set of associated computer devices or systems, as desired.

Typically, system 1000 operates in association with input from a user. The user input typically causes system 1000 to perform specific desired information-processing tasks, including processes for authenticating access to resources in an electronic device, such as an IC, according to various embodiments. System 1000 in part uses computer device 1005 to perform those tasks. Computer device 1005 includes information-processing circuitry, such as a central-processing unit (CPU), controller, microcontroller unit (MCU), etc., although one may use more than one such device or information-processing circuitry, as persons skilled in the art would understand.

Input device 1010 receives input from the user and makes that input available to computer device 1005 for processing. The user input may include data, instructions, or both, as desired. Input device 1010 may constitute an alphanumeric input device (e.g., a keyboard or keypad), a pointing device (e.g., a mouse, roller-ball, light pen, touch-sensitive apparatus, for example, a touch-sensitive display, or tablet), or both. The user operates the alphanumeric keyboard or keypad to provide text, such as ASCII characters, to computer device 1005. Similarly, the user operates the pointing device to provide cursor position or control information to computer device 1005.

Video/display device 1015 displays visual images to the user. Video/display device 1015 may include graphics circuitry, such as graphics processors, as desired. The visual images may include information about the operation of computer device 1005, such as graphs, pictures, images, and text. Video/display device 1015 may include a computer monitor or display, an electronic display, a projection device, and the like, as persons of ordinary skill in the art would understand. If system 1000 uses a touch-sensitive display, the display may also operate to provide user input to computer device 1005.

Storage/output device 1020 allows computer device 1005 to store information for additional processing or later retrieval (e.g., softcopy), to present information in various forms (e.g., hardcopy), or both. As an example, storage/output device 1020 may include a magnetic, optical, semiconductor, or magneto-optical drive capable of storing information on a desired medium and in a desired format. As another example, storage/output device 1020 may constitute a printer, plotter, or other output device to generate printed or plotted expressions of the information from computer device 1005. In some embodiments, in addition or as an alternative to storing information, storage device 1020 may provide information (e.g., previously stored information) to one or more components or parts of system 1000, for example, computer device 1005.

Computer-readable medium 1025 (or computer program product) interrelates structurally and functionally to computer device 1005. Computer-readable medium 1025 stores, encodes, records, and/or embodies functional descriptive material. By way of illustration, the functional descriptive material may include computer programs, computer code, computer applications, and/or information structures (e.g., data structures, databases, and/or file systems). When stored, encoded, recorded, and/or embodied by computer-readable medium 1025, the functional descriptive material imparts functionality. The functional descriptive material interrelates to computer-readable medium 1025. In some embodiments, computer-readable medium 1025 is non-transitory, as desired.

Information structures within the functional descriptive material define structural and functional interrelations between the information structures and computer-readable medium 1025 and/or other aspects of system 1000. These interrelations permit the realization of the information structures' functionality.

Moreover, within such functional descriptive material, computer programs define structural and functional interrelations between the computer programs and computer-readable medium 1025 and other aspects of system 1000. These interrelations permit the realization of the computer programs' functionality. Thus, in a general sense, computer-readable medium 1025 includes information, such as instructions, that when executed by computer device 1005, cause computer device 1005 (system 1000, generally) to provide the functionality prescribed by a process, computer program, software, firmware, method, algorithm, etc., as included (partially or entirely) in computer-readable medium 1025.

By way of illustration, computer device 1005 reads, accesses, or copies functional descriptive material into a computer memory (not shown explicitly in the figure) of computer device 1005 (or a separate block or memory circuit coupled to computer device 1005, as desired). Computer device 1005 performs operations in response to the material present in the computer memory. Computer device 1005 may perform the operations of processing a computer application that causes computer device 1005 to perform additional operations. Accordingly, the functional descriptive material exhibits a functional interrelation with the way computer device 1005 executes processes and performs operations.

Furthermore, computer-readable medium 1025 constitutes an apparatus from which computer device 1005 may access computer information, programs, code, and/or applications. Computer device 1005 may process the information, programs, code, and/or applications that cause computer device 1005 to perform additional or desired tasks or operations.

Note that one may implement computer-readable medium 1025 in a variety of ways, as persons of ordinary skill in the art would understand. For example, memory within computer device 1005 (and/or external to computer device 1005) may constitute a computer-readable medium 1025, as desired.

Alternatively, computer-readable medium 1025 may include a set of associated, interrelated, coupled (e.g., through conductors, fibers, etc.), or networked computer-readable media, for example, when computer device 1005 receives the functional descriptive material from a network of computer devices or information-processing systems. Note that computer device 1005 may receive the functional descriptive material from computer-readable medium 1025, the network, or both, as desired. In addition, input(s) and/or output(s) of system 1000 may be received from, or provided to, one or more networks (not shown), as desired.

Various circuits and blocks described above and used in exemplary embodiments may be implemented in a variety of ways and using a variety of circuit elements or blocks. For example, controller 150, timer 160, counter 170, increment circuit 175, input register 155, output register 165, IC 550 (see FIGS. 4, 6, and 7), system 1000 or any of its components/blocks (see FIG. 8) may generally be implemented using digital or mixed-signal circuitry. The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand. In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand. The mixed-signal circuitry may include analog to digital converters (ADCs), digital to analog converters (DACs), etc.) in addition to analog circuitry and digital circuitry, as described above, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. A method of providing access to a resource in an integrated circuit (IC), the method comprising:
determining whether an attempt is made to access the resource;
determining whether a count of attempts to access the resource equals a maximum count; and
authenticating cryptographically a command for accessing the resource if the count of attempts to access the resource is less than the maximum count.

2. The method according to claim 1, further comprising allowing access to the resource if authenticating cryptographically the command indicates that the command is valid.

3. The method according to claim 2, further comprising resetting the count of attempts to access the resource.

4. The method according to claim 1, further comprising incrementing the count of attempts to access the resource if authenticating cryptographically the command indicates that the command is invalid.

5. The method according to claim 1, wherein the resource comprises a debug interface of the IC.

6. A method of providing access to a resource in an integrated circuit (IC), the method comprising:
determining whether an attempt is made to access the resource;
waiting for a duration of time, wherein the duration of time is zero for a first attempt to access the resource;
authenticating cryptographically a command for accessing the resource; and
selectively allowing access to the resource if authenticating cryptographically the command indicates that the command is valid.

7. The method according to claim 6, further comprising setting the duration of time to zero if the command is valid.

8. The method according to claim 6, further comprising incrementing the duration of time if authenticating cryptographically the command indicates that the command is invalid.

9. The method according to claim 8, wherein incrementing the duration of time further comprises increasing the duration of time linearly.

10. The method according to claim 9, wherein incrementing the duration of time further comprises increasing the duration of time exponentially.

11. The method according to claim 6, wherein the resource comprises a debug interface of the IC.

12. An integrated circuit (IC), comprising:
a protection circuit to provide countermeasures against an attempt to access a resource in the IC, the protection circuit comprising a controller to selectively provide access to the resource in the IC by authenticating a command by (a) determining whether a count of attempts exceeds a maximum count; or (b) inserting a wait state before authenticating the command.

13. The IC according to claim 12, wherein the command is authenticated cryptographically.

14. The IC according to claim 12, wherein the resource comprises a debug interface of the IC.

15. The IC according to claim 12, wherein the protection circuit comprises a controller coupled to a counter.

16. The IC according to claim 15, wherein the counter comprises an increment circuit.

17. The IC according to claim 16, wherein the increment circuit increases a count of attempts when the attempts to access the resource in the IC is made.

18. The IC according to claim 16, wherein the increment circuit increases a duration of the wait period between successive attempts to access the resource if the command is invalid.

19. The IC according to claim 18, wherein the duration of the wait period is increased linearly.

20. The IC according to claim 18, wherein the duration of the wait period is increased exponentially.
